(19) United States
(12) Patent Application Publication
(10) Pub. No.: US 2012/0016691 A1
(43) Pub. Date: Jan. 19, 2012

(54) AUTOMATED PATIENT CARE RESOURCE ALLOCATION AND SCHEDULING

(76) Inventors: Crispian Sievenpiper, (US); Jeffrey Solliday-McRoy, (US); Adrian Warner, (US)

(21) Appl. No.: 13/196,348

(22) Filed: Aug. 2, 2011

Related U.S. Application Data
(63) Continuation-in-part of application No. 12/241,193, filed on Sep. 30, 2008.

(51) Int. Cl. G06Q 50/00

(52) U.S. Cl. 705/2

(57) ABSTRACT

An automated patient care resource allocation and medical workflow system includes an agent with a memory in communication with a processor. The memory includes program instructions for execution by the processor to determine a need for a medical resource by a patient, determine a location and availability of the medical resource, and automatically schedule an available medical resource to the patient.

### CROSS-REFERENCE TO RELATED APPLICATIONS

This application is a continuation-in-part application of, claims priority to and the benefit of, U.S. patent application Ser. No. 12/241,193, filed on Sep. 30, 2008, entitled “A System and Method to Deliver a Quality of Healthcare”, the disclosure of which is incorporated herein by reference in its entirety.

### BACKGROUND

1. Field of the Invention

The present disclosure generally relates to healthcare services, and more particularly to an automated patient care workflow and scheduling system.

2. Description of Related Art

Hospitals and other medical facilities (e.g., imaging centers, cardiology treatment centers, emergency rooms, surgical suites, etc.) include various workflows to deliver diagnosis or treatment to admitted patients. These workflows include events that employ various resources, such as imaging rooms, physicians, nurses, radiologists, cardiologists, clinicians, technicians, etc. To provide adequate patient care in a hospital, health care or long term care facility, certain medical or hospital resources and services, generally referred to herein as “patient care resources”, need to be brought together. These patient care resources can generally include, for example, imaging rooms and equipment, physicians, nurses, radiologists, cardiologists, clinicians, technicians, patient monitoring equipment, scanners, medical supplies and medications. In some cases, these patient care resources are not always immediately available or proximate to each other, and can result in delays in delivering needed healthcare to a patient. It would be advantageous to be able to monitor and enter patient locations, resource locations and resource availability, relative to a patient's healthcare needs, into a workflow system or automated patient care resource scheduling.

Patient care resource allocation in a hospital setting is typically based on a time schedule. For example, a patient may require periodic monitoring or the administration of a drug at a threshold time interval. The resource(s) required for the monitoring or the administration of the drug is scheduled to be allocated at the threshold time interval irrespective of the actual patient condition or need at the time.

In some cases, it could be more effective to deliver patient care resources and services to a patient based upon demand, rather than just merely time. In the manufacturing world, “just-in-time” style manufacturing systems trigger material orders when a stock level falls below a predetermined threshold value. It would be advantageous to be able to schedule patient care resources and services based upon a patient need measured in real-time, rather than solely a time-based interval or schedule.

Accordingly, it would be desirable to provide a system that addresses at least some of the problems identified above.

### SUMMARY OF THE INVENTION

As described herein, the exemplary embodiments overcome one or more of the above or other disadvantages known in the art.

One aspect of the exemplary embodiments relates to an automated patient care resource allocation and medical workflow system. In one embodiment, the system includes an agent with a memory in communication with a processor. The memory includes program instructions for execution by the processor to determine a need for a medical resource by a patient, determine a location and availability of the medical resource, and automatically schedule an available medical resource to the patient.

Another aspect of the disclosed embodiments relates to a computer program product. In one embodiment, the computer program product includes computer readable program code means. The computer readable code means is configured to, when executed in a processor device, determine a need for a medical resource by a patient, determine a location and availability of the medical resource, and automatically schedule an available medical resource to the patient.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein.

### BRIEF DESCRIPTION OF THE DRAWINGS

In the drawings:

FIG. 1 is a schematic block diagram of one embodiment of a patient care resource allocation and scheduling system incorporating aspects of the present disclosure;

FIG. 2 is a schematic block diagram of another embodiment of a patient care resource allocation and scheduling system incorporating aspects of the present disclosure;

FIG. 3 is a flowchart illustrating one embodiment of a method for patient care resource allocation and scheduling incorporating aspects of the present disclosure; and

FIG. 4 is a block diagram of an embodiment of an apparatus that can be used to practice aspects of the disclosed embodiments.

### DETAILED DESCRIPTION OF THE INVENTION

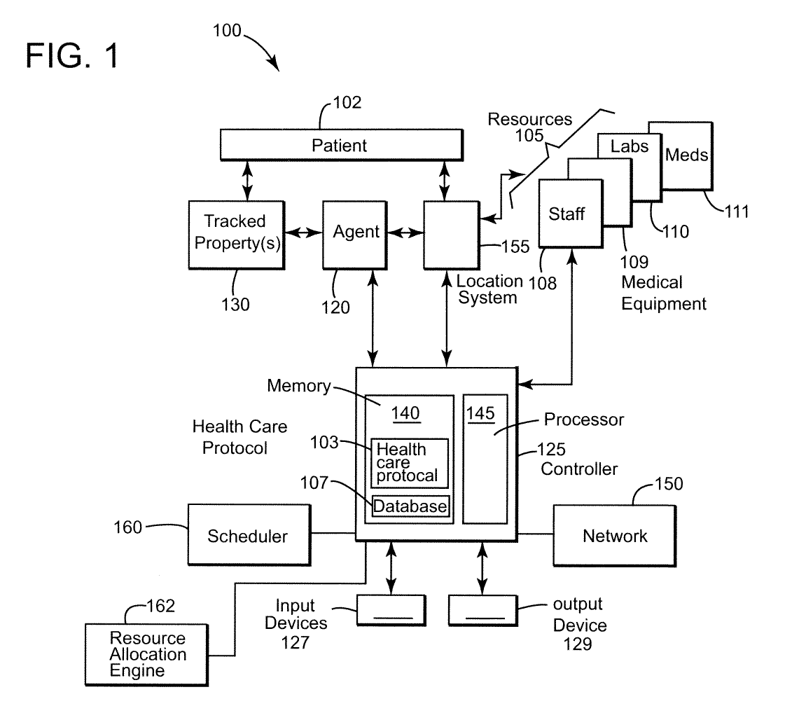

Referring to FIG. 1, an exemplary patient care resource allocation and scheduling system in accordance with the aspects of the disclosed embodiments is shown. In operation, the patient care resource and allocation system 100 allocates medical resources and services 105 based on the health care needs of a patient 102 that are measured in real time rather than simply on a time-based schedule. Thus, in one embodiment, the patient care resource and allocation system 100, or component(s) thereof, provide automated on-demand delivery of health care resources and services.

As is illustrated in FIG. 1, the automated patient care resource allocation and scheduling system 100 manages patient care resources 105, such as staff 108, medical equipment 109, lab and diagnostic imaging systems 110 and medications 111, in the delivery of healthcare to a patient 102. In one embodiment, the system 100 is configured to monitor certain health information and medical data of the patient 102, referred to herein as “tracked properties” 130. The tracked properties 130 generally include data and diagnostic information that reflects a health state or condition data of the patient 102. Examples of the tracked properties 130 can include for example, but are not limited to, vital signs, electrocardiogram (ECG) data, laboratory results, diagnostic test data and diagnostic imaging data, etc. In alternate embodiments, the tracked properties 130 can include any diagnostic data related to the patient 102. The source of the tracked properties data 130 can include, but are not limited to, clocks, timers, blood pressure monitors, electrocardiogram (ECG) monitors, ventilation monitors, blood analysis devices, drug and fluid dispensing devices, blood sugar monitors, temperature monitors, telemetry units, pulse oximetry devices, diagnostic imaging devices, electronic medical records, plans of care, disease templates and protocols, etc. In alternate embodiments, the source of the tracked properties data 130 can include any suitable source of medical data and health information.

The system 100 is configured to identify the tracked properties 130 and determine whether one or more of the resources 105 need to be scheduled and allocated to the patient 102. In one embodiment, determining whether one or more of the resources 105 need to be scheduled comprises accessing a patient plan of care or electronic medical record (EMR), both generally referred to herein as “health care protocol 103”, comparing the tracked properties 130 to the health care protocol 103, and identifying the resources 105 that may be required. Once the resource(s) 105 are identified, the system 100 will determine the availability and location of the resource(s) 105, and optimize the delivery of the resource(s) 105 to the patient 102 based on criteria such as availability, location and need.

In one embodiment, the system 100 includes an agent 120 that is in communication with a central server or controller 125, via wired or wireless connections. The agent 120 generally includes, is coupled to or is communication with a processor that is operable to receive and monitor the tracked properties 130 associated with the patient 102. In one embodiment, the agent 120 is comprised of machine-readable instructions that are executable by a processing device.

The agent 120 is configured to receive and/or interpret the data corresponding to the tracked properties 130. In one embodiment, the data is received directly by the agent 120 from the source of each tracked property 130. For example, in one embodiment, a blood pressure monitoring device can communicate blood pressure data of the patient 102 to the agent 120, via a wired or wireless connection. Alternatively, a suitable interface, such as a telemetry unit, between the agent 120 and each source device can be used to communicate the data corresponding to each tracked property 130 to the agent 120. For example, a telemetry unit can be configured to receive the data for each tracked property 130, process and format the data, and transmit the data to the agent 120. In one embodiment, data corresponding to a tracked property 130 can be manually entered into the system 100, such as through the health care protocol 103.

The agent 120 is generally configured to acquire the data corresponding to the tracked properties 130 in real-time. In one embodiment, the agent 120 can be created and associated with the patient 102 upon admission of the patient 102 to the healthcare facility, such as a hospital, long term care facility, nursing home or rehabilitation center, for example. Although only a single patient 102 and agent 120 is illustrated in this example, it will be understood that the aspects of the disclosed embodiments are not so limited, and the system 100 can manage one or more patients 102 using one or more agents 120. The agent 120 is configured to be able to communicate or collaborate in real-time between the patient 102 as well as other agents 120. Although FIG. 1 shows the general location of the agent 120 as located at the patient 102, in one embodiment, the agent 120, or portions thereof, can be otherwise located at the central server or controller 125, or at another remote location(s).

In one embodiment, the agent 120 can be programmed with instructions of a health care protocol 103 to direct the patient 102 through the resources 105. In one embodiment, the health care protocol 103 is stored in a memory 140 of the controller 125. The agent 120 can measure the tracked properties 130 relative to the health care protocol 103 to monitor the medical condition or state of the patient 102, output the appropriate level of urgency of the patient 102 for viewing by the staff 108 as well as re-factor or schedule other resources 105. In one embodiment, the agent 120 acts as the patient's proxy when negotiating and scheduling resources 105. The agent 120 can be configured to update the health care protocol 103 upon completion of any test, or with current tracked properties 130 data. The agent 120 can also acquire or receive data from the resources 105 as the health care facility manages the medical condition of the patient 102. The agent 120 can leverage an increased ability to gather information by the integration of patient care management with the system 100. The system 100 can be generally operable via the agent 120 to track the dynamics of individual patients 102 over time and allocate and schedule their respective needs and demands for resources 105.

The agent 120 is configured to identify a health care need and determine if one or more of the health care resources 105 are needed. In one embodiment, the agent 120 can also determine an urgency, severity of or priority associated with the health care need and the needed resource 105. In a chaos-based work flow, such as that disclosed in U.S. patent application Ser. No. 11/972,888, filed on 11 Jan. 2008, defining the urgency of the needed resource or care is also referred to as a “bid.”

The system 100 can further include a location and tracking system 155 having a general ability to supervise or track all of the resources 105 and patients 102 in the workflow. In one embodiment, the location and tracking system 155, comprised of machine-readable instructions that are executable by a processing device, is configured to sense, determine and track a location of each patient 102 as well as one or more of resources 105 The location system 155 can be configured to communicate a location of each patient 102 and/or each resource 105 relative to a predetermined reference. The location system 155 can be configured to track in coordinates, room number, floor number, etc. The location system 155 can be in wired or wireless communication with the controller 125. In one embodiment, the location and tracking system 155 can employ electromagnetic technology, radio frequency identification (RFID) technology, optical technology, global positioning system (GPS) technology, cellular telecommunications, other position measuring or locating technology, or a combination thereof, as is known in the art.

When it is determined that one or more resources 105 are needed, the agent 120 forwards patient data, which can include for example, a unique patient identifier obtained from the hospital admission system or health care protocol, for example, and an identification of the required resource(s) 105 to a scheduler engine 160. The scheduler engine 160, which in one embodiment is comprised of machine-readable instructions that are executable by a processing device, is configured to locate and allocate the required resource(s) 105 to the patient(s) 102. In one embodiment, the scheduler engine 160 identifies the resource(s) 105 that need to be allocated to the patient 102, the location and availability of the resource(s) 105, as well as the time threshold in which the resource(s) 105 must be provided to the patient 102. The time, location and availability attributes are then used by the scheduler engine 160 to optimize the delivery of the resource 105 to the patient 102. For example, in a situation where the patient 102 requires an X-ray, the scheduler engine 160 can locate one or more diagnostic imaging devices. The location and availability are then compared to the patient need. The diagnostic imaging device which satisfies the patient need, in terms of availability and location, is then scheduled for delivery to the patient 102. For example, if the patient need is urgent, the closest available diagnostic imaging device is scheduled for the patient 102. If the need is not urgent, the next available diagnostic imaging device can be scheduled.

The scheduler engine 160 is generally a rules-based scheduler, where demand is based on measured patient needs. For example, in one embodiment, the scheduler engine 160 is state-based, and uses the tracked properties 130, such as the heart rate, to identify a severity of a patient's condition. The severity of the patient's condition or state can be used to determine need as well as the priority of the allocation of resource(s) 105. In one embodiment, the resource allocation requirements or “bid” for an emergent patient will override the resource allocation requirements for a less emergent patient. The scheduler engine 160, in conjunction with the agent 120 is configured to qualitatively compare multiple patients at substantially the same time, and allocate and schedule resources 105 accordingly.

In one embodiment, the scheduler engine 160 communicates with a resource allocation engine 162 to identify and locate the resource(s) 105 required. The resource allocation engine 162, which in one embodiment comprises machine-readable instructions that are executable by a processor, is configured to communicate with the location system 155 to determine a current location and availability of the resource(s) 105 required by the patient 102. The resource allocation engine 162 can be configured to optimize the availability and location attributes of the resource 105 relative to the patient 102 and determined needs, and allocate the resource(s) 105 to the patient 102 accordingly.

The aspects of the disclosed embodiments integrate the monitoring and gathering of the tracked properties 130 and the health care protocol 103 with workflow driven health care resource delivery scheduling. In one embodiment, the agent 120 is coupled to, or able to access, a repository or database 107 of templates and protocols, each correlated to the diagnosis of specific disease states or medical conditions. In one embodiment, the database 107 is a memory coupled or integrated with a processing device, such as the controller 125 shown in FIG. 1. The memory includes the templates and protocols. The memory may also include a machine-readable database that stores the templates and protocols. The particular format in which the data and information is stored is not limited by the aspects of the disclosed embodiments, and can include any suitable medical information and record storage standard or format. The Digital Imaging and Communications in Medicine (DICOM) is just one example of such a standard that enable the integration of a variety of medical information devices, such as scanners, servers, workstations, printer and network hardware. Although a database 107 is generally referred to herein, in alternate embodiments, the templates and protocols can be stored in or on any suitable data storage medium that is electronically accessible. Examples can include, but are not limited to, processor devices such as computing devices, flash memory, data storage media, non-transitory mediums or memory devices. The database 107 can also be located remotely from the controller 125 and/or accessible via the network 150. The network 150, which can comprise for example a wide area network (WAN), or wireless local area network (WLAN), can allow the controller 125 to communicate with other systems, such as a hospital admission system, or the Internet. In one embodiment, the database 107 comprises national, or international or medical advisory repositories of healthcare standards, protocols and performance metrics.

In one embodiment, the controller 125 is configured to compare the tracked properties data 130 relative to the health care protocol 103 and the templates and protocols in the database 107 to determine a health care need and transmit this information to the agent 120. In an alternate embodiment, the agent 120 is configured to retrieve data from the health care protocol 103 and database 107 and compare the retrieved data to the tracked properties data 130 to determine a health care need. The database 107 can also include instructions to initiate at least one medical diagnostic protocol (e.g. imaging, laboratory tests), and/or identify the required medical resources that correspond to an apparent diagnosis and diagnostic protocol based on the tracked properties 130 and health care protocol 103.

In one embodiment, the tracked properties 130 from the patient 102 and the health care protocol 103 are used to evaluate and schedule care and treatment in, for example, a long term care facility. In an embodiment where the health care facility is a long term care facility, the agent 102 can comprise a Quality of Care monitoring engine. In the management of the quality of delivery of healthcare to a patient at a long-term care facility, the template and protocol database 107 will generally include or acquire the protocol or quality of care metrics to address the needs and risks for each patient, and arrange the metrics in a template associated with various conditions for delivery of healthcare at the long-term care facility. At a long-term care facility, the protocol for the delivery of healthcare or treatment may involve different needs or requirements for diagnostic tests or procedures in other health care settings, such as a hospital.

One embodiment of the agent 120 can be configured to sense, detect, or track a presence and an awareness. “Presence”, as that term s generally used herein, refers to an ability of the agent 120 to express or communicate a current state of activity (e.g., available, partially in-use, fully in use, etc.) of itself to other agent 120 in the system 100. “Awareness” generally refers to an ability of the agent 120 to sense the presence (as described above) of other agent 120 in the system 100. For example, awareness can include an ability of one agent 120 to track the activities of the agent 120 or patients 102 correlated thereto in the workflow. The combination of presence and awareness enables each agent 120 to initiate a communication or collaboration with one another to identify or calculate a length of time to get a response from one another. Awareness also allows the agent 120 initiating a communication or collaboration with other agents 120 to make decisions about mode of communication (e.g., route, wireless versus wired connection, etc.) to establish contact amongst multiple agents 120. An ability to express or communicate the presence and leverage the awareness allows the agent 120 to initiate communications or collaboration with one another, as well as the controller 125 and to respond to communications from the controller 125 and other agents 120 associated with other patients 102.

In one embodiment, the agent 120 can receive/communicate data relating to the tracked properties, receive/communicate requests for a work order and a report status, receive/communicate patient notifications to report for an event or step in the workflow (e.g., testing, imaging), receive/communicate problems, and receive/communicate orders for or results of tests. The agent 120 can also be operable to contact respective staff 110, such as physicians waiting for patient information, using an identified best mode of communication (e.g., beeper, home telephone, email, cellular phone, text message, etc.). Additionally, staff 110 or patients 102 can communicate via computer messaging systems or other known type of input (e.g., keyboard, touch-screen, voice recognition, etc.), with the agent 120 in the workflow community to gain access to information and collaborate with the agent 120 at any given point in time of the workflow.

As is illustrated in FIG. 1, the controller 125 is in communication with the agent 120. The controller 120 includes a memory 140 generally operable to receive updated values or measurements of tracked properties 130 on a continuous or periodic basis of the patient 102, as well as store and update on or more of the health care protocol 103 and template and protocol database 107.

The controller 125 can also include a processor 145 generally configured to execute program instructions stored in the memory 140. Although the memory 140 and processor 145 are shown at the controller 125, it should be understood that the memory 140 or processor 145 can comprise remote portions at the agent 120 or other components of the system 100.

The controller 125 can also be in communication with an input device 127 and an output device 129. Examples of the input device 127 include a keyboard, touch screen or graphic interface, mouse, toggle switches, etc. Examples of the output device 129 can include monitors, terminals, touch-screens or graphic interfaces, kiosks, dashboards, etc. In one embodiment, the patient 102 or staff 108 can input data related to the tracked properties, the health care protocol 103, or requests for one or more of resource(s) 105.

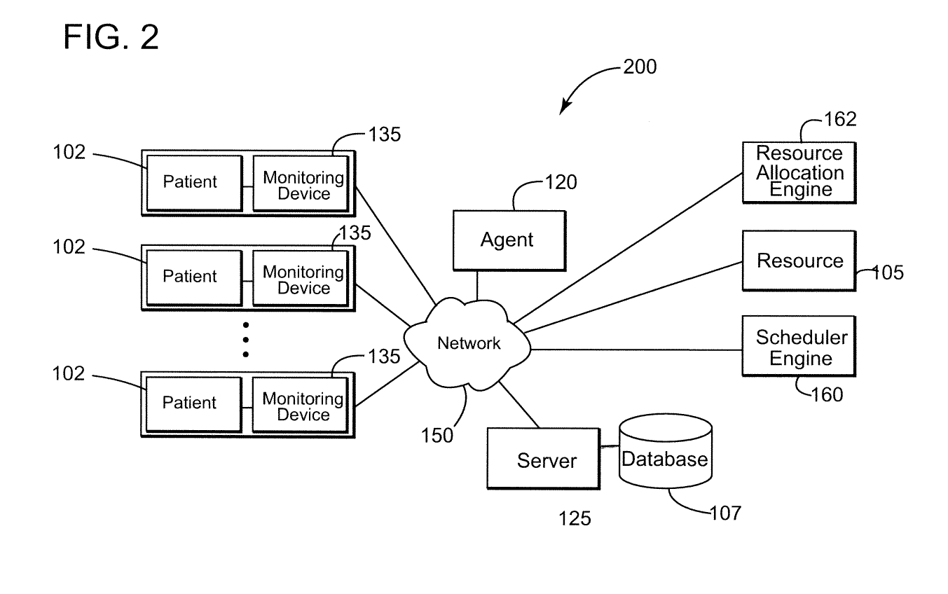

FIG. 2 illustrates another embodiment of an automated patient care resource allocation and scheduling system 200. In this example, the components of the system 200 are communicatively coupled together via the network 150. In this example, a monitoring device 135, such as a telemetry unit, is used to gather and communicate patient data, such as the tracked properties 130 of FIG. 1, to the agent 120. Although the monitoring device 135 is shown in this example as being remote from the agent 120, in one embodiment, the agent 120 and the monitoring device 135 can comprises a single device or system.

Each of the monitoring device 135, agent 120, server 125 database 107, scheduler engine 160, resources 105 and resource allocation engine 162 can be communicatively coupled to the network 150, via for example, wired or wireless connections, and can include, where required, suitable communication and connectivity agents and interfaces, such as modems or transceivers for example, that can be used to format, transform and transmit the data and information as needed. In one embodiment, the agent 120 is configured to transmit and receive data and information and automatically allocate and schedule resources over the network 150, using an electronic mail system or other suitable communication and notification system, such as a wired, wireless or cellular communication system. For example, in one embodiment, the agent 120 can be configured to enable a short message service (SMS) to a care provider's handheld or mobile device in order to allocate the required resource, which in this example may be the services of staff 108. Alternatively, the agent 120 can be configured to enable the transmission and reception of any suitable electronic message, such as an email for example, to a care provider in order to determine the availability of allocate and schedule a resource.

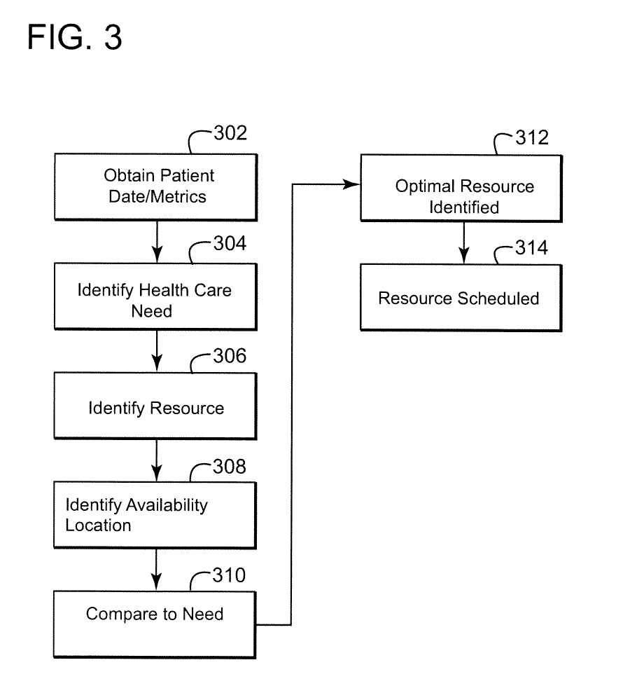

Referring to FIG. 3, an automated patient care resource allocation and scheduling process flow incorporating aspects of the disclosed embodiments is illustrated. In one embodiment, the patient data and metrics, such as the tracked properties 130 of FIG. 1, are obtained 302, such as by the agent 120. A health care need is determined and identified 304. In one embodiment, the health care need is determined by comparing the tracked properties 130 to the health care protocol 103 and the templates and protocols in the database 107, which provide directed diagnostic analysis and diagnosis. A health care resource, such as one or more of resource 105 of FIG. 1, corresponding to the identified health care need is identified 306. The determination 304 can include determining a need-based status of the patient relative to other patients, and ranking multiple patients in terms of emergent status. If one or more of resources 105 are warranted or required, the availability and location of the identified resource is identified 308. The availability and location of the identified resource is compared 310 to a priority of the health care need. The resource that is optimal in terms of availability and location, relative to the priority of the health care need, is determined and identified 312. The identified optimal resource is then scheduled 314 for delivery to the patient 102.

For example, if the tracked properties 130 of FIG. 1 indicate that the patient 102 is in a hypoglycemic state, a diabetic need is identified. In this example, the required resource 105 is glucose. The agent 102 will communicate with the scheduler engine 160 to automatically generate an order for the glucose. The location and availability of the glucose can be determined, which can include determining whether the glucose is available at the pharmacy of the hospital or at the nursing station corresponding to the patient. If the glucose is available at the nursing station, and the need is indicated as a relative immediate priority, the order can include this information as transmitted to the pharmacy department and/or nursing station, in accordance with the local protocol. The pharmacy department and/or nursing station can accordingly process the request and arrange for the delivery and administration of the glucose the patient 102 in a real-time and timely fashion. In accordance with the aspects of the disclosed embodiments, the real-time patient needs or condition is taken into consideration when determining when and how to allocate these resources 105. The medication delivery and administration can now be scheduled in an automated fashion based on a real-time or emergent need, and not just a time-based need.

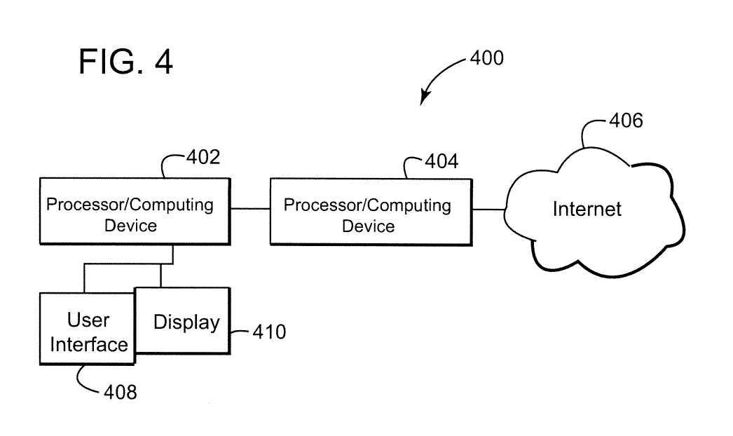

The disclosed embodiments may also include software and computer programs incorporating the process steps and instructions described above. In one embodiment, the programs incorporating the process described herein can be stored on or in a computer program product and executed in one or more computers. FIG. 4 is a block diagram of one embodiment of a typical apparatus that can be used to practice aspects of the disclosed embodiments. The apparatus 400, such as for example one or more of the agent 102, controller 125 and scheduler 160, can each include computer readable program code means stored on a computer readable storage medium for carrying out and executing the process steps described herein. In one embodiment, the computer readable program code is stored in a memory of the apparatus 400. In alternate embodiments, the computer readable program code can be stored in memory or memory medium that is external to, or remote from apparatus 400. The memory can be direct coupled or wireless coupled.

In one embodiment, the apparatus 400 may include and/or be coupled to one or more processor devices or computer systems 402, 404 that are capable of sending information to each other and receiving information from each other. In one embodiment, the apparatus 400 could include a server computer or controller adapted to communicate with a network 406, such as for example, a wireless area network. In one embodiment, the network 406 can be communicatively coupled with the Internet. The devices 402, 404 can be linked together in any conventional manner, including for example, a modem, wireless connection, hard wire connection, fiber optic or other suitable data link. Information can be made available to the apparatus 400 using a communication protocol typically sent over a communication channel or other suitable communication line or link.

The apparatus 400 is generally configured to utilize program storage devices embodying machine-readable program source code that is adapted to cause the apparatus to perform and execute the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

The apparatus 400, including the agent 120, controller 125 and scheduler 160 may also include one or more processors for executing stored programs, and each may include a data storage or memory device on its program storage device for the storage of information and data. The computer program or software incorporating the processes and method steps incorporating aspects of the disclosed embodiments may be stored in one or more computer systems or on an otherwise conventional program storage device.

In one embodiment, the apparatus 400 includes a user interface 408 and/or a display interface 410 from which aspects of the present disclosure can be accessed, viewed and controlled. The user interface 408 and display interface 410, which in one embodiment can be integrated, are generally configured to allow the input of data, queries and commands to the apparatus 400, as well as present the results of such data, queries and commands.

The aspects of the disclosed embodiments provide for an automated patient care resource allocation and medical workflow system that provides automated scheduling of health care resources based on the real-time needs of the patient. The health and medical state data of the patient, such as vital signs, diagnostic imaging data and diagnostic test data, are automatically gathered and monitored in real-time to determine the medical state of the patient and whether a health care need exists. Determining if a health care need exists can include comparing the data against the patient plan of care and/or pre-determined templates and protocols. When a health care need is identified, patient data and identification information is automatically entered into an automated patient care workflow system and the required resources are identified. The location and availability of the required resources are optimized relative to the location and need of the patient, and allocated and scheduled for delivery to the patient. In multiple patient situations, emergent health care needs of one patient can override less emergent needs of other patient. The aspects of the disclosed embodiments allow the allocation of resources to be scheduled based on the measured real-time health care needs of the patient, rather than just a time schedule, and generally provide a more efficient manner in which to automatically schedule and deliver health care resources to patients in a health care setting, such as a hospital or long term care facility.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An automated patient care resource allocation and medical workflow system for allocating a medical resource to a patient, comprising:
an agent with a memory in communication with a processor, the memory including program instructions for execution by the processor to:
determine a need for a medical resource by the patient;
determine a location and availability of the medical resource; and
automatically schedule an available medical resource to the patient.

2. The system of claim 1, wherein the memory further includes program instructions for execution by the processor to:
determine a priority of the need for the medical resource; and
determining a most available medical resource based on the priority of the need; and wherein the scheduled medical resource is the most available medical resource.

3. The system of claim 1, wherein the memory further includes program instructions for execution by the processor to:
compare a location of the patient to the location of the medical resource; and
determine a closest medical resource relative to the location of the patient;
and wherein the scheduled medical resource is the closest medical resource.

4. The system of claim 1, wherein the memory further includes program instructions for execution by the processor to:
obtain medical state information from the patient in real-time;
compare the obtained medical state information to a health care protocol corresponding to the patient; and
determine the need for the medical resource based on the comparison.

5. The system of claim 4, wherein the memory further includes program instructions for execution by the processor to compare the obtained medical state information and the health care protocol with a disease template and protocol to determine the health care need.

6. The system of claim 1, further comprising:
a telemetry unit communicatively coupled to the agent, the telemetry unit obtaining medical state information corresponding to the patient and providing the obtained medical state information to the agent.

7. The system of claim 1, further comprising:
an electronic messaging unit coupled to the agent, the memory including program instructions for execution by the processor to cause the electronic messaging unit to notify the scheduled medical resource.

8. The system of claim 1, further comprising:
a resource location system communicatively coupled to the agent, the resource location system configured to track a physical location of the patient and the medical resource, the memory including program instructions for execution by the processor to correlate the physical location of the patient and the physical location of the medical resource.

9. The system of claim 1, wherein the memory further includes program instructions for execution by the processor to:
determine a priority of the need for the medical resource; and
determine a most available medical resource based on the priority of the need;
compare a location of the patient to the location of the medical resource; and
determine a closest medical resource relative to the location of the patient;
and wherein the scheduled medical resource is a closest and most available medical resource.

10. A computer program product, comprising:
computer readable program code means, the computer readable program code means when executed in a processor device, being configured to:
determine a need for a medical resource;
determine a location and availability of the medical resource; and
automatically scheduling an available medical resource.

11. The computer program product of claim 10, wherein the computer program code means when executed in the processor device is further configured to:
determine a priority of the need for the medical resource; and
determine a most available medical resource based on the priority of the need,
wherein the scheduled medical resource is the most available medical resource.

12. The computer program product of claim 10, wherein the computer program code means when executed in the processor device is further configured to:
compare a location of the patient to the location of the medical resource; and
determine a closest medical resource relative to the location of the patient; wherein the scheduled medical resource is the closest medical resource.

13. The computer program product of claim 10, wherein the computer program code means when executed in the processor device is further configured to:
obtain medical state information from the patient in real-time;
compare the obtained medical state information to a health care protocol corresponding to the patient; and
determine the need for the medical resource based on the comparison.

14. The computer program product of claim 13, wherein the computer program code means when executed in the processor device is further configured to compare the obtained medical state information and the health care protocol with a disease template and protocol to determine the health care need.

15. The computer program product of claim 10, wherein the computer program code means when executed in the processor device is further configured to
determine a priority of the need for the medical resource; and
determine a most available medical resource based on the priority of the need;
compare a location of the patient to the location of the medical resource; and
determine a closest medical resource relative to the location of the patient;
and wherein the scheduled medical resource is a closest and most available medical resource.
